(19) United States
(12) Patent Application Publication
(10) Pub. No.: US 2008/0317335 A1
(43) Pub. Date: Dec. 25, 2008

(54) METHOD OF IDENTIFICATION ACCORDING TO SELECTED PATTERNS AND RELATED COMPUTER SYSTEM

(76) Inventor: Yao-Tsung Chang, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/874,217

(22) Filed: Oct. 18, 2007

(30) Foreign Application Priority Data
Jun. 23, 2007 (TW) 096122791

(51) Int. Cl. G06K 9/62

(52) U.S. Cl. 382/159

(57) ABSTRACT

A method of identification of a computer system includes: (a) selecting a first partial pattern from a pattern group; (b) determining whether the first partial pattern selected in step (a) corresponds with a predetermined rule; and (c) controlling the computer system whether to operate a program according to a determining result in step (b).

### BACKGROUND OF THE INVENTION

1. Field of the Invention

The present invention relates to a method of identification and a related computer system, and more particularly, to a method of identification according to selected patterns and a related computer system.

2. Description of the Prior Art

In general, identification of a computer system for installing software always uses license key or username/password mechanism. The license key and username/password are input with a keyboard as a number or a character with special symbols. Although it's a convenient way for identification, the license key and the username/password are encoded to standard codes of the computer so that the license key and the username/password is compromised easily by plug-in programs or hackers. The safety of the computer system and intellectual property are violated by distribution of compromised identification data on internet. Furthermore, it is difficult for users to memorize the identification data of the numeral and word types causing failure of identification and login of the software. There is a need to find identification of the computer system with safety and easy memorization.

### SUMMARY OF THE INVENTION

It is therefore a primary objective of the claimed invention to provide a method of identification according to selected patterns and a related computer system for solving the above-mentioned problem.

According to the claimed invention, a method of identification of a computer system includes: (a) selecting a first partial pattern from a pattern group; (b) determining whether the first partial pattern selected in step (a) corresponds with a predetermined rule; and (c) controlling the computer system whether to operate a program according to a determining result in step (b).

According to the claimed invention, a computer system includes a memory module for storing the pattern group and a program, a selecting module for selecting a first partial pattern from the pattern group stored in the memory module, a determining means for determining whether the first partial pattern selected by the selecting module corresponds with a predetermined rule, and a control module coupled to the determining means for controlling the computer system whether to operate the program according to a determining result of the determining means.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a computer system according to a preferred embodiment of the present invention.

FIG. 2 is a flowchart of identification of the computer system according to selected patterns according to the preferred embodiment of the present invention.

FIG. 3 is a diagram of a pattern group displayed by a display module according to the preferred embodiment of the present invention.

FIG. 4 is a diagram of a first partial pattern displayed by the display module according to the preferred embodiment of the present invention.

FIG. 5 is a diagram of patterns and characters for the identification displayed by the display module according to the preferred embodiment of the present invention.

### DETAILED DESCRIPTION

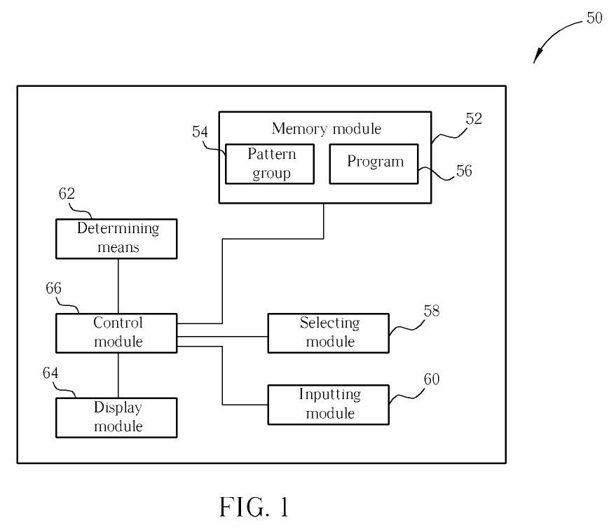

Please refer to FIG. 1. FIG. 1 is a functional block diagram of a computer system 50 according to a preferred embodiment of the present invention. The computer system 50 can be a desktop computer or a notebook computer. The computer system 50 includes a memory module 52 for storing a pattern group 54 and a program 56. The computer system 50 further includes a selecting module 58 for selecting patterns from the pattern group 54 stored in the memory module 52. The selecting module 58 can be a mouse for selecting patterns from the pattern group 54 with a cursor. The computer system 50 further includes an inputting module 60 for inputting a word, a number, or a character with special symbols. The inputting module 60 can be a keyboard. The computer system 50 further includes a determining means 62 for determining whether the patterns selected by the selecting module 58 corresponds with a predetermined rule. The determining means 62 can be hardware, software, firmware, and so on. The computer system 50 further includes a display module 64 for displaying the pattern group 54. The computer system 50 further includes a control module 66 coupled to the determining means 62 for controlling the computer system 50 whether to operate the program 66 according to a determining result of the determining means 62.

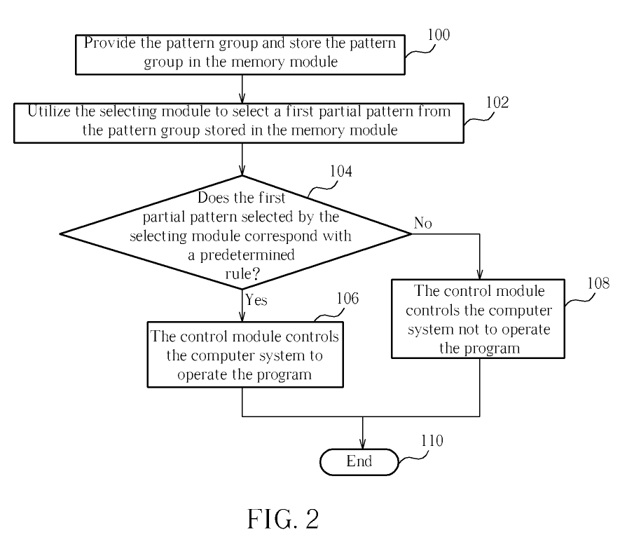

Please refer to FIG. 2. FIG. 2 is a flowchart of identification of the computer system 50 according to selected patterns according to the preferred embodiment of the present invention. The method includes following steps:

Step 100: Provide the pattern group 54 and store the pattern group 54 in the memory module 52.

Step 102: Utilize the selecting module 58 to select a first partial pattern from the pattern group 54 stored in the memory module 52.

Step 104: The determining means 62 determines whether the first partial pattern selected by the selecting module 58 corresponds with a predetermined rule. If yes, go to step 106; if no, go to step 108.

Step 106: The control module 66 controls the computer system 50 to operate the program 56.

Step 108: The control module 66 controls the computer system 50 not to operate the program 56.

Step 110: End.

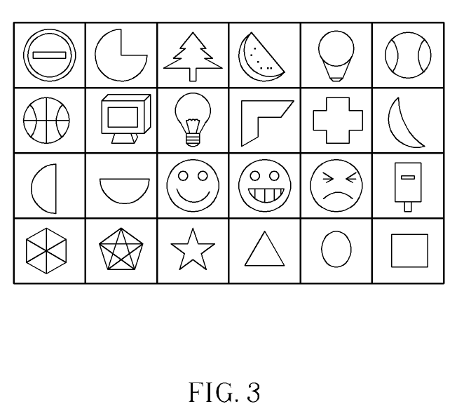

The detailed description is introduced as follows. Please refer to FIG. 3. FIG. 3 is a diagram of the pattern group 54 displayed by the display module 64 according to the preferred embodiment of the present invention. For example, the pattern group 54 can be shown as an array of patterns. The pattern group 54 can includes any type of patterns, such as unrelated patterns or related patterns. The related patterns can belong to a certain category, such as a fruit category, an animal category, and so on, for being memorized easily. The pattern group 54 can be built in the memory module 52 before the computer system 50 leaves the factory for the identification database of booting login. The pattern group 54 also can be stored in the memory module 52 when an application program is installed in the computer system 50 for the identification database of the license key or the username/password. The pattern group 54 can be generated randomly, that is, the pattern group 54 can be composed of different patterns every time or of same patterns in different orders. The number or rank of patterns of the pattern group 54 can be changed so as to increase complexity and safety of the identification of the computer system 50.

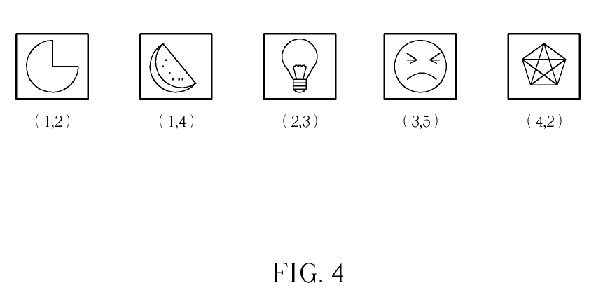

When a user logins the computer system 50, installs an application program in the computer system 50 with a license key, or uses the application program with the username/password, the user can use the selecting module 58 to select the first partial pattern from the pattern group 54 displayed by the display module 64. The selecting module 58 can be a mouse so that the user can select patterns from the pattern group 54 with a cursor instead of keying in characters regularly with a keyboard. For example, please refer to FIG. 4. FIG. 4 is a diagram of the first partial pattern displayed by the display module 64 according to the preferred embodiment of the present invention. The first partial pattern is composed of individual patterns of the pattern group 54 located in (1,2), (1,4), (2,3), (3,5), (4,2) wherein the first number inside the bracket stands for row location and the second number inside the bracket stands for column location. The first partial pattern can be composed of a single pattern or a plurality of patterns in different locations of the pattern group 54.

Then the determining means 62 determines whether the first partial pattern corresponds with the predetermined rule. For example, each pattern of the pattern group 54 corresponds to an internal code. The determining means 62 is capable of transforming the first partial pattern into corresponding internal codes, that is, transforming each pattern of the first partial pattern into a corresponding internal code. The internal codes can be any type of codes. Afterward, the determining means 62 determines whether the internal codes correspond with the predetermined rule with an algorithm. If the determining means 62 determines that the internal codes correspond with the predetermined rule, it means the first partial pattern selected by the selecting module 58 stands for the correct license key, the correct username/password, or the correct identification data. At this time, the control module 66 controls the computer system 50 to operate the program 56 so as to login the computer system 50, continues installing the application program, allow the user to use the application program, and so on. On the contrary, if the determining means 62 determines that the internal codes do not correspond with the predetermined rule, it means the first partial pattern selected by the selecting module 58 stands for the incorrect license key, the incorrect username/password, or the incorrect identification data. At this time, the control module 66 can not control the computer system 50 to operate the program 56, that is, not to login the computer system 50, not to continue installing the application program, not to allow the user to use the application program, and so on.

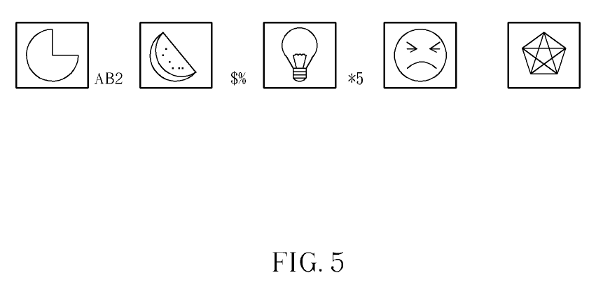

Besides, the character can be mixed with the pattern as the license key, the username/password, or the identification data, for increasing complexity and safety of the identification of the computer system 50. Please refer to FIG. 5. FIG. 5 is a diagram of patterns and characters for the identification displayed by the display module 64 according to the preferred embodiment of the present invention. The user can use the selecting module 58 to select patterns from the pattern group 54 and use the inputting module 60 to input a character, a number, a symbol, and so on. Afterward, the determining means 62 transforms the patterns selected by the selecting module 58 and the characters input by the inputting module 60 into corresponding internal codes and determines whether the internal codes correspond with the predetermined rule with the algorithm.

Furthermore, the predetermined rule can conform to either a predetermined order or not. That is, not only the correct first partial pattern and character but also the correct selecting and inputting order have to be complied for passing the identification mechanism so as to increase complexity and safety of the identification of the computer system 50. Or the correct first partial pattern and the character have to be complied merely, and it is not necessary for the correct selecting and inputting order for passing the identification mechanism instead.

The patterns of the pattern group 54 can be predetermined for the license key, the password, or the identification data. First a second partial pattern from the pattern group 54 corresponding with the predetermined rule can be selected before the user uses the selecting module 58 to select the first partial pattern from the pattern group 54 stored in the memory module 52. The second partial pattern stands for the license key, the password, or the identification data. The second partial pattern can be built in the memory module 52 before the computer system 50 leaves the factory for the identification data of booting login. The second partial pattern also can be stored in the memory module 52 when an application program is installed in the computer system 50 for the license key or the username/password. The second partial pattern also can be set by the user with the selecting module 58 for the personal password. When the user logins the computer system 50, installs the application program in the computer system 50 with the license key, or uses the application program with the username/password, the user uses the selecting module 58 to select the first partial pattern from the pattern group 54. Then the determining means 62 determines whether the first partial pattern corresponds with the predetermined second partial pattern for a basis of passing the identification mechanism. The predetermined order also can be consider with whether the first partial pattern corresponds with the predetermined second partial pattern.

In contrast to the prior art, the present invention utilizes the selection of patterns as the identification mechanism, such as the license key, the username/password, or the identification data. The user can select patterns from the pattern group with the cursor instead of keying in characters regularly with the keyboard so as to prevent the plug-in programs from generating test data automatically. It can reduce compromised possibility. In addition, the pattern is memorized more easily than the character, the number, and the word. The patterns of the pattern group can be of meaningful combination, like a certain category, such as a fruit category, an animal category, and so on, for being memorized easily. It can prevent the user from forgetting the identification data causing failure of identification and login of the software. Therefore, the present invention provides an identification mechanism of the related computer system with safety and easy memorization.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of identification of a computer system comprising:
(a) selecting a first partial pattern from a pattern group;
(b) determining whether the first partial pattern selected in step (a) corresponds with a predetermined rule; and
(c) controlling the computer system whether to operate a program according to a determining result in step (b).

2. The method of claim 1 wherein the first partial pattern comprises a pattern or a plurality of patterns.

3. The method of claim 1 wherein step (a) comprises selecting the first partial pattern from the pattern group with a cursor.

4. The method of claim 1 wherein step (b) comprises transforming the first partial pattern into a corresponding internal code and determining whether the internal code corresponds with the predetermined rule.

5. The method of claim 4 wherein step (b) further comprises determining whether the internal code corresponds with the predetermined rule with an algorithm.

6. The method of claim 1 wherein step (b) comprises determining whether the first partial pattern in step (a) corresponds with a predetermined order.

7. The method of claim 1 further comprising inputting a character and step (b) comprising determining whether the first partial pattern selected in step (a) and the character correspond with the predetermined rule.

8. The method of claim 1 further comprising:
(d) providing the pattern group before step (a); and
(e) selecting a second partial pattern from the pattern group corresponding with the predetermined rule before step (a);
wherein step (b) comprises determining whether the first partial pattern selected in step (a) corresponds with the second partial pattern.

9. The method of claim 8 wherein step (e) comprises selecting the second partial pattern from the pattern group in a predetermined order before step (a) and step (b) further comprises determining whether the first partial pattern selected in step (a) corresponds with the second partial pattern and the predetermined order.

10. The method of claim 1 wherein step (c) comprises controlling the computer system to operate the program when the first partial pattern selected in step (a) corresponds with the predetermined rule.

11. The method of claim 1 wherein step (c) comprises controlling the computer system not to operate the program when the first partial pattern selected in step (a) does not correspond with the predetermined rule.

12. A computer system comprising:
a memory module for storing the pattern group and a program;
a selecting module for selecting a first partial pattern from the pattern group stored in the memory module;
a determining means for determining whether the first partial pattern selected by the selecting module corresponds with a predetermined rule; and
a control module coupled to the determining means for controlling the computer system whether to operate the program according to a determining result of the determining means.

13. The computer system of claim 12 wherein the first partial pattern comprises a pattern or a plurality of patterns.

14. The computer system of claim 12 wherein the selecting module is a mouse.

15. The computer system of claim 12 wherein the determining means is for transforming the first partial pattern into a corresponding internal code and determining whether the internal code corresponds with the predetermined rule.

16. The computer system of claim 15 wherein the determining means is for determining whether the internal code corresponds with the predetermined rule with an algorithm.

17. The computer system of claim 12 wherein the determining means is for determining whether the first partial pattern corresponds with a predetermined order.

18. The computer system of claim 12 further comprising an inputting module for inputting a character and the determining means is for determining whether the first partial pattern and the character correspond with the predetermined rule.

19. The computer system of claim 18 wherein the inputting module is a keyboard.

20. The computer system of claim 12 wherein the selecting module is for selecting a second partial pattern from the pattern group corresponding with the predetermined rule before selecting the first partial pattern from the pattern group and the determining means is for determining whether the first partial pattern corresponds with the second partial pattern.

21. The computer system of claim 20 wherein the selecting module is for selecting the second partial pattern from the pattern group in a predetermined order and the determining means is for determining whether the first partial pattern corresponds with the second partial pattern and the predetermined order.

22. The computer system of claim 12 wherein the control module is for controlling the computer system to operate the program when the determining means determines the first partial pattern corresponds with the predetermined rule.

23. The computer system of claim 12 wherein the control module is for controlling the computer system not to operate the program when the determining means determines the first partial pattern does not correspond with the predetermined rule.

24. The computer system of claim 12 further comprising a display module for displaying the pattern group.
